(19) United States
(12) Patent Application Publication
(10) Pub. No.: US 2019/0255830 A1
(43) Pub. Date: Aug. 22, 2019

(54) AUTOMATIC LEAKPROOF STRUCTURE FOR INFLATABLE AIRBAG

(71) Applicant: CATHAY CONSOLIDATED INC., Yilan County (TW)

(72) Inventor: Tsung Hsi Liu, Yilan County (TW)

(21) Appl. No.: 15/902,979

(22) Filed: Feb. 22, 2018

(51) Int. Cl. B32B 27/40; B32B 27/12; B32B 27/30; B32B 43/00

(52) U.S. Cl. CPC B32B 27/40; B32B 27/12; B63B 7/08; B32B 43/00; B32B 27/304

(57) ABSTRACT

An automatic leakproof structure for an inflatable airbag contains: a first layer, a second layer, and an accommodation chamber. The first layer is located on an internal portion of the inflatable airbag, the second layer is covered on the first layer, and the accommodation chamber is defined inside the first layer. Preferably, a flexibility of the first layer is different from the second layer. Thereby, the automatic leakproof structure avoids gas leakage out of the accommodation chamber, after the inflatable airbag is pierced by an object (such as a nail).

### FIELD OF THE INVENTION

The present invention relates to an automatic leakproof structure for an inflatable airbag which avoids gas leakage after the inflatable airbag is pierced by an object (such as a nail).

### BACKGROUND OF THE INVENTION

A conventional inflatable airbag is employed to air bed, inflatable boat, inflatable swim ring, and inflatable headrest, etc., but it is not durable.

As illustrated in FIG. 1, the conventional inflatable airbag 1 contains a protective layer 1 and an accommodation chamber 10 defined inside the protective layer 1.

Referring to FIGS. 2 and 3, when the protective layer 11 is pierced by an object 3 (such as a nail), a through hole 111 produces, and gas leaks out of the through hole 111 from the accommodation chamber 10 quickly.

The present invention has arisen to mitigate and/or obviate the afore-described disadvantages.

### SUMMARY OF THE INVENTION

The primary aspect of the present invention is to provide an automatic leakproof structure for an inflatable airbag which avoids gas leakage after the inflatable airbag is pierced by an object (such as a nail).

To obtain above-mentioned aspect, an automatic leakproof structure for an inflatable airbag provided by the present invention contains: a first layer, a second layer, and an accommodation chamber. The first layer is located on an internal portion of the inflatable airbag, the second layer is covered on the first layer, and the accommodation chamber is defined inside the first layer. Preferably, a flexibility of the first layer is different from the second layer.

Preferably, the first layer is made of plastic material.

Preferably, the first layer is made of thermoplastic polyurethane (TPU) or polyvinyl chloride (PVC).

Preferably, the second layer is a lamination made of fabric and plastic.

Preferably, the flexibility of the first layer is more than the second layer.

Preferably, the automatic leakproof structure further contains a third layer covered on the second layer and a fourth layer covered on the third layer.

### BRIEF DESCRIPTION OF THE DRAWINGS

FIG. 1 is a cross sectional view of a conventional inflatable airbag.

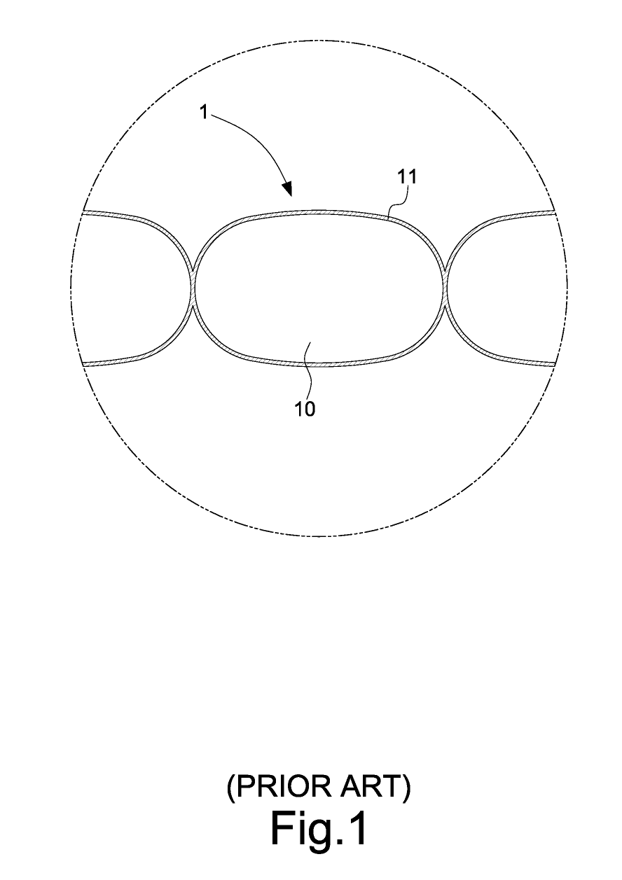

FIG. 2 is a cross sectional view showing the conventional inflatable airbag being pierced by a nail.

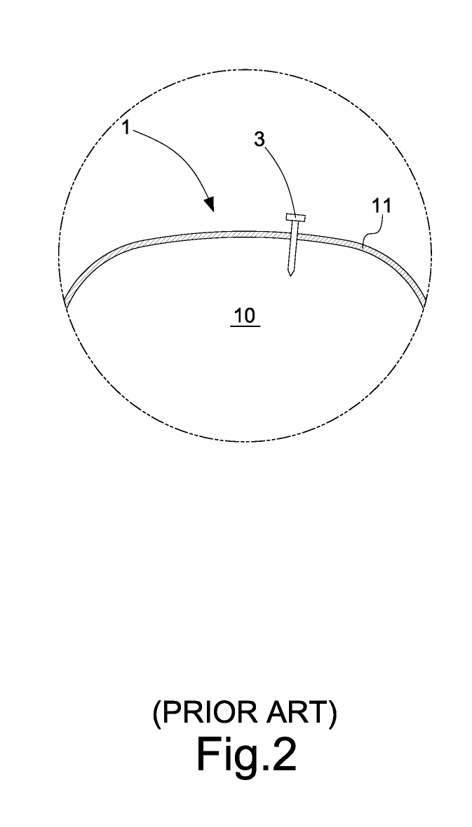

FIG. 3 is a cross sectional view showing gas leaking out of a through hole after the conventional inflatable airbag being pierced by the nail.

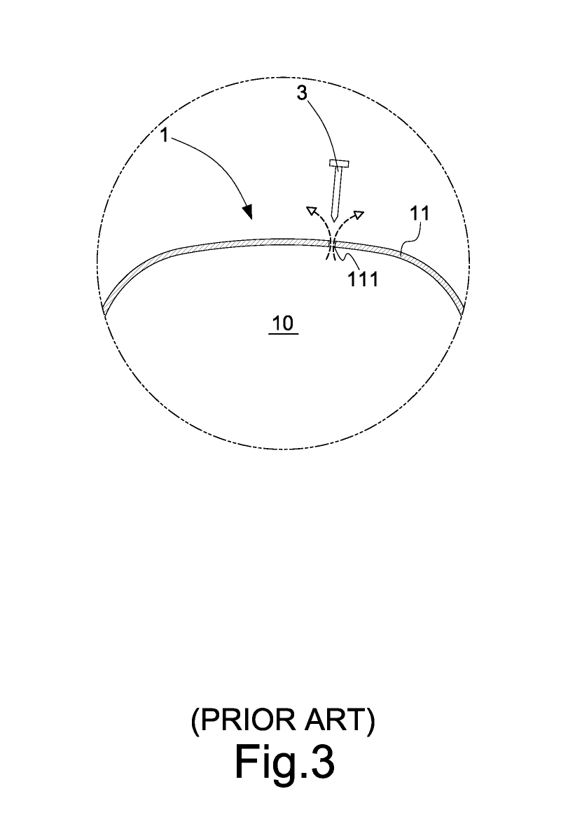

FIG. 4 is a cross sectional view showing the assembly of an automatic leakproof structure of an inflatable airbag according to a first embodiment of the present invention.

FIG. 5 is a cross sectional view showing the operation of the automatic leakproof structure of the inflatable airbag according to the first embodiment of the present invention.

FIG. 6 is another cross sectional view showing the operation of the automatic leakproof structure of the inflatable airbag according to the first embodiment of the present invention.

FIG. 7 is a cross sectional view showing the operation of the automatic leakproof structure of the inflatable airbag according to a second embodiment of the present invention.

FIG. 8 is another cross sectional view showing the operation of the automatic leakproof structure of the inflatable airbag according to the second embodiment of the present invention.

### DETAILED DESCRIPTION OF THE PREFERRED EMBODIMENTS

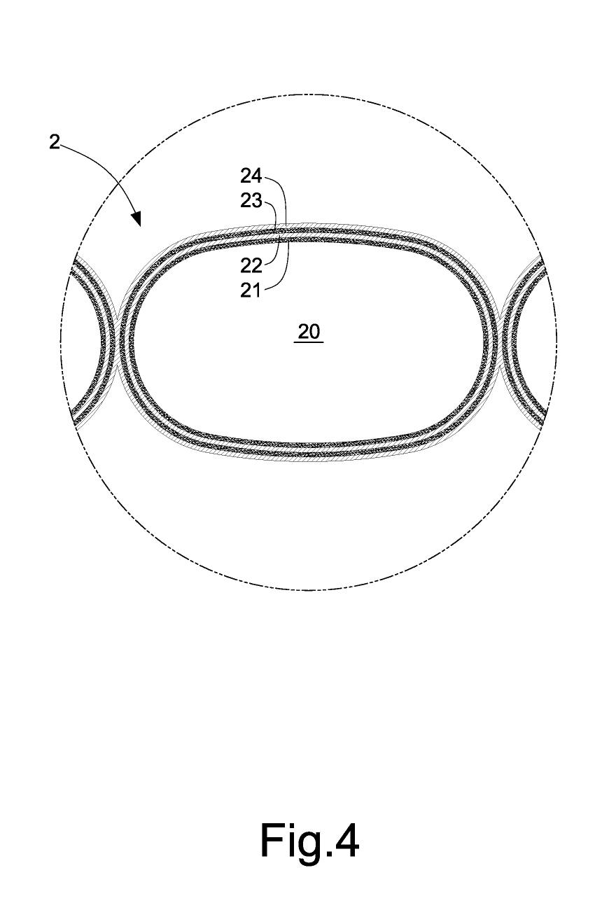

With reference to FIG. 4, an inflatable airbag 2 according to a first embodiment of the present invention comprises: a first layer 21 located on an internal portion of the inflatable airbag 2, a second layer 22 covered on the first layer 21, an accommodation chamber 20 defined inside the first layer 21 so as to accommodate gas feed into the accommodation chamber 20. A flexibility of the first layer 21 is more than the second layer 22, for example, the first layer 21 is made of plastic material which is thermoplastic polyurethane (TPU) or polyvinyl chloride (PVC), and the second layer 22 is a lamination made of fabric and plastic. The inflatable airbag 2 further comprises a third layer 23 covered on the second layer 22 and a fourth layer 24 covered on the third layer 23, wherein the third layer 23 is made of plastic material which is thermoplastic polyurethane (TPU) or polyvinyl chloride (PVC), and the fourth layer 24 is another lamination made of fabric and plastic. Accordingly, the gas is fed into the accommodation chamber 20 so as to inflate the inflatable airbag 2.

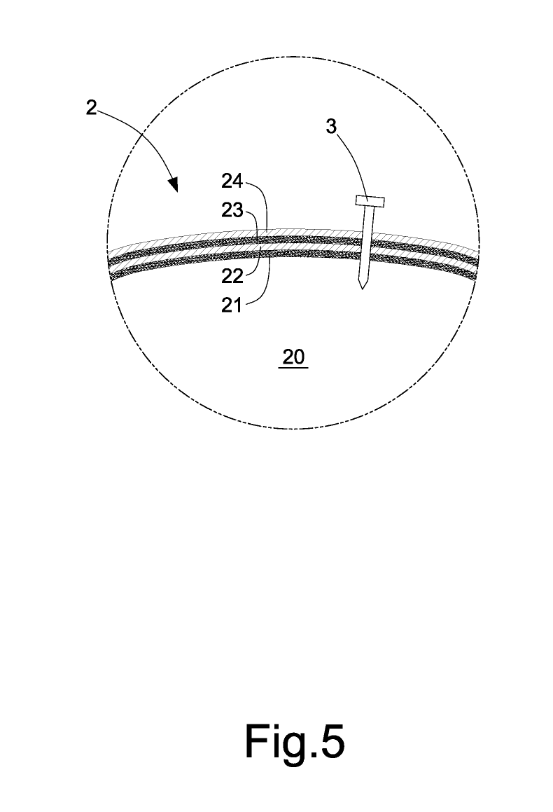

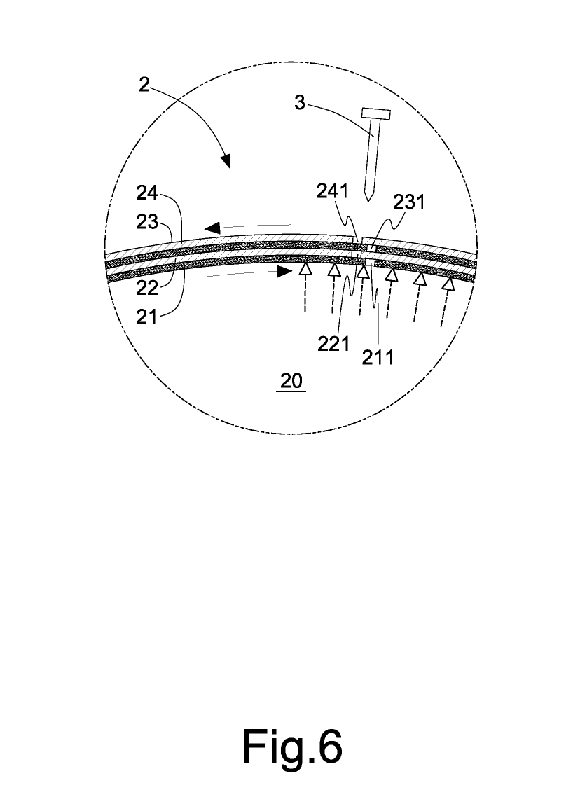

Referring to FIG. 5, after the inflatable airbag 2 is pierced by an object 3 (such as a nail) to produce a first through hole 211 on the first layer 21, a second through hole 221 on the second layer 22, a third through hole 231 on the third layer 23, and a fourth through hole 241 on the fourth layer 24, the object 3 is removed. Due to the flexibility of the first layer 21 is different from the second layer 22, the firth through hole 211 misaligns with the second through hole 221 by way of a gas pressure in the accommodation chamber 20, hence the first through hole 211 is closed by the second layer 22, as shown in FIG. 6. Meanwhile, the second through hole 221 is closed by the first layer 21 so as to avoid gas leakage out of the inflatable airbag 2. Similarly, the flexibility of the second layer 22 is different from the third layer 23, and the flexibility of the third layer 23 is different from the fourth layer 24, so the second through hole 221 misaligns with the third through hole 231, and the third through hole 231 misaligns with the fourth through hole 241, such that the third through hole 231 is closed by the fourth layer 24 and the second layer 22, the second through hole 221 is closed by the third layer 23, and the fourth through hole 241 is closed by the third layer 23, thus the inflatable airbag 2 is closed automatically so as to avoid gas leakage.

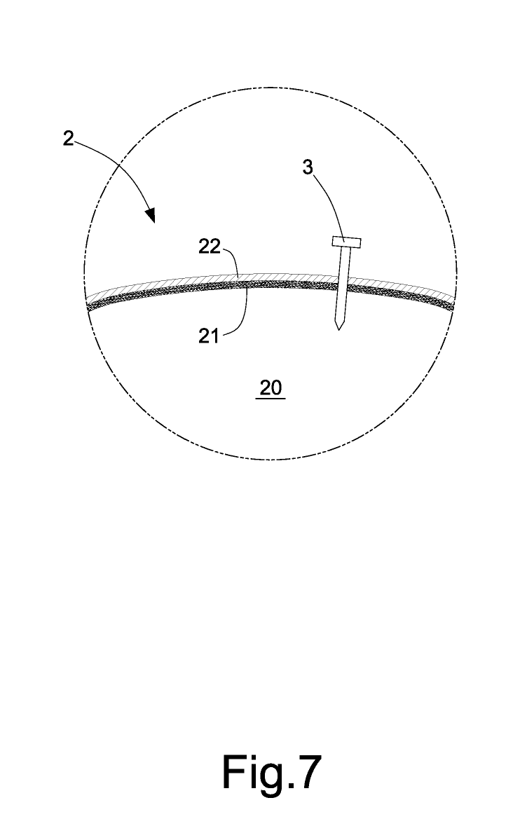

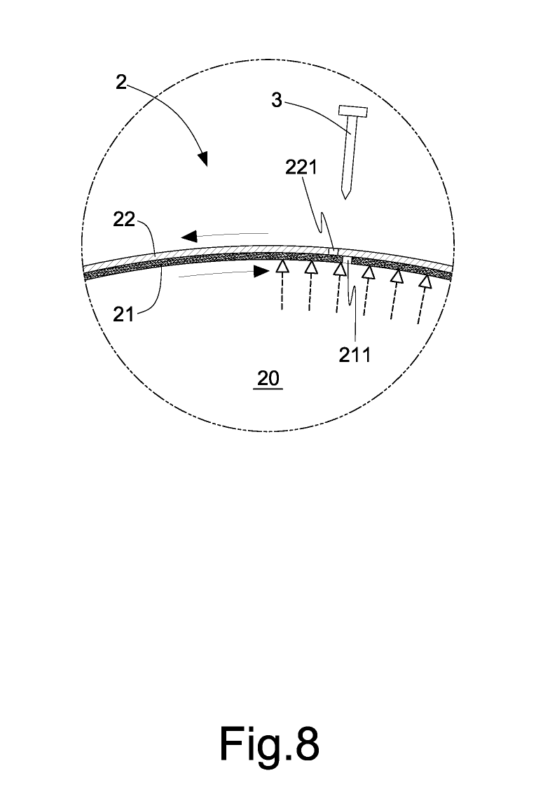

Referring further to FIGS. 7 and 8, an inflatable airbag 2 according to a second embodiment of the present invention comprises: a first layer 21 located on an internal portion of the inflatable airbag 2, a second layer 22 covered on the first layer 21, and an accommodation chamber 20 defined inside the first layer 21 so as to accommodate gas feed into the accommodation chamber 20.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An automatic leakproof structure for an inflatable airbag comprising:
a first layer located on an internal portion of the inflatable airbag;
a second layer covered on the first layer; and
an accommodation chamber defined inside the first layer;
wherein a flexibility of the first layer is different from the second layer.

2. The automatic leakproof structure as claimed in claim 1, wherein the first layer is made of plastic material.

3. The automatic leakproof structure as claimed in claim 1, wherein the first layer is made of thermoplastic polyurethane (TPU) or polyvinyl chloride (PVC).

4. The automatic leakproof structure as claimed in claim 1, wherein the second layer is a lamination made of fabric and plastic.

5. The automatic leakproof structure as claimed in claim 1, wherein the flexibility of the first layer is more than the second layer.

6. The automatic leakproof structure as claimed in claim 1 further comprising a third layer covered on the second layer and a fourth layer covered on the third layer.
